(19) United States
(12) Patent Application Publication
(10) Pub. No.: US 2007/0134637 A1
(43) Pub. Date: Jun. 14, 2007

(54) Medical simulation device with motion detector

(75) Inventors: Ran Bronstein, Modiln (IL); Shaul Israeli, Ramat-Gan (IL)

Correspondence Address: Martin D. Moynihan;PRTSI, Inc., P.O. Box 16446, Arlington, VA, 22215, US

(73) Assignee: Simbionix Ltd., Lod (IL)

(21) Appl. No.: 11/603,197

(22) Filed: Nov. 22, 2006

Related U.S. Application Data
(60) Provisional application No. 60/748,220, filed on Dec. 8, 2005.

(51) Int. Cl. G09B 23/28

(52) U.S. Cl. 434/262

(57) ABSTRACT

A computerized system for performing a simulated medical procedure, comprises: (a) a physically simulated interventional instrument that looks and feels like an endoscope, for providing user input to a computer simulated medical angioplasty procedure; (b) a motion detector circuit to provide navigation signals representative of the movement of the physically simulated interventional instrument, the motion detector comprising a laser radiation detector, used for determining the location of the interventional instrument in a predetermined area in proximity to the detector and a laser radiation emitter used for emitting a laser beam toward the predetermined area; and (c) a movement calculation unit receiving the navigation signals from the motion detector circuit, and programmed to update the position of a corresponding software simulation of the interventional instrument. A tactile feedback mechanism may be included for providing simulated tactile feedback back to the physically simulated interventional instrument according to the calculated position of the software interventional instrument in the computer simulation.

### RELATED APPLICATIONS

This Application claims the benefit of U.S. Provisional Patent Application No. 60/748,220 filed on Dec. 8, 2005, the contents of which are hereby incorporated by reference.

### FIELD AND BACKGROUND OF THE INVENTION

The present invention relates to an apparatus, system and method for teaching and training students in medical procedures, and more particular but not exclusively to a system for training students in the procedures of angioplasty.

Angioplasty is a common name for a minimally invasive, catheter-based, endovascular procedure that is used for reopening of narrow blood vessels, blood flow restoration and other surgical and diagnostic procedures in the vasculature. Essentially, Angioplasty is performed by inserting a catheter, which is a hollow flexible tube, into a blood vessel, usually through the skin of the groin or arm of the subject, typically with the assistance of a guidewire. The catheter, guidewire or any other interventional instrument (hereinafter: “interventional instrument”) is manipulated by a trained physician through specialized controls. The end of the interventional instrument which is inserted into the subject can contain various surgical tools, such as a deflated balloon or a stent. The physician must maneuver the interventional instrument carefully within the blood vessel without damaging its walls. Such procedures are typically carried out in a CathLab using fluoroscopy that yields current images of a changing situation. The images guide the physician. Interventional fluoroscopy is a specialty in which the physician utilizes fluoroscopic images to perform the aforementioned therapeutic procedure. Physicians currently rely on real-time fluoroscopic 2D images, available as analog video or digital information viewed on video monitors.

However, the lack of direct view of the treated vascular tract is one factor which renders angioplasty a complex and difficult procedure to master. Such lack of feedback and lack of depth perception also increase the difficulty of hand-eye coordination and correct manipulation of the angioplasty device. Thus, angioplasty is a complicated procedure that requires a high level of skill to perform and it may be hard to learn to control the tools through the indirect point of view of the real-time fluoroscopic 2D images.

Because a mistake in such a complicated setting can be dangerous a high level of dexterity is required from the specialized physicians. Thus, comprehensive training in performing such a procedure is an obligatory phase for these trainees.

In the traditional model for medical education students observe and assist more experienced physicians. However, such observation alone cannot provide the necessary training for such complicated medical procedures. In addition, the performance of such procedures on substitutes such as animals and human cadavers, does not bestow the trainee with the same visual and tactile sensations of a live human patient. Thus, traditional medical training is not adequate for complex medical procedures.

In order to provide more realistic training and to reduce healthcare costs, surgical simulators that have been developed in an attempt to replicate the tactile sensations and the visual feedback for these procedures, in order to provide improved medical training without endangering human patients.

There are a few known simulation devices developed for this purpose. An example of such a simulation device is disclosed in U.S. Pat. No. 5,403,191 in which the disclosed device is a box containing simulated human organs. Various surgical laparoscopic procedures can be performed on the simulated organs. Visual feedback is provided by a system of mirrors. However, the system of both visual and tactile feedback is primitive in this device, and does not provide a true representation of the visual and tactile sensations which would accompany such surgical procedures in a human patient.

Attempts to provide a more realistic and accurate experience from medical simulation devices are disclosed in U.S. Pat. No. 6,538,634, issued on Mar. 25, 2003, in which the disclosed apparatus that simulates image guided angioplasty surgery with a box containing a simulated organ. This application discloses comprises a rolling ball or two roller and encoder assemblies as motion detectors, clamping means and a processor. The mechanical detectors are responsive to movement of the practice intervention instrument. Movement information is entered into the apparatus and the instrument can be manipulated by the operator. The motion detectors produce signals representative of displacement and rotation of the interventional instrument movement. The processor receives these displacement and rotation signals, and is programmed to plot the path of the interventional instrument as it is manipulated by the user. Additionally, the processor produces the controlling signal to the clamping means in response to the instantaneous position along the path. The processor may be coupled to a display device for displaying an image of the instantaneous position of the interventional instrument movement therealong, or other information. Another attempt to provide a realistic surgical simulation for a similar procedure is described in U.S. Pat. No. 6,926,531, issued on Aug. 9, 2005 of an apparatus for use in a simulated intervention device for an endoscopy system. This apparatus's motion device comprises a rotational disc on which a plurality of rollers is mounted to surround the axis of rotation of the disc to provide linear and rotary sensing of the position of the probed interventional instrument.

However, the mechanical motion detectors as described in U.S. Pat. No. 6,926,531 and in U.S. Pat. No. 6,538,634 are subjected to a number of shortcomings. The main shortcoming is the accuracy of the mechanical motion detectors. Such a transducer does not reflect the exact movement of the instrument movement and does not aptly reflect minor alterations in the interventional instrument position. In addition, the precision of those transducers is affected by the level of cleanliness of the interventional instrument movement or the motion detectors, resulting in a reduction in the accuracy of the outputs when the equipment is dirty. Another shortcoming is deterioration of the mechanic parts or damage to its surface, and degradation of the ease of rotation for the contact rollers owing to the accumulation of dirt or of lint or because of wear or both. This concern requires constant maintenance of the motion detectors and the interventional instrument as a whole to ensure accurate measurement of catheter motion.

Thus, there is a widely recognized need, not satisfied by the prior art, for an accurate motion detectors for measuring the small changes in the position of the navigating device within such simulated intervention devices apparatus, and it would be highly advantageous to have, surgical simulator for angioplasty procedures devoid of the above mentioned limitations.

### SUMMARY OF THE INVENTION

The present invention includes a method and a system to simulate the minimally invasive medical angioplasty procedures. Such a system is designed to simulate the actual medical procedure of angioplasty as closely as possible by providing both a simulated medical instrument, tactile feedback and visual feedback as the simulated procedure is performed by a trainee on the simulated patient. In particular, the present invention enables an accurate simulation of the insertion and maneuvering of a catheter, guidewire or other navigation devices, within a simulated vascular tract or system which is being examined through the performance of the minimally invasive medical procedure.

According to the present invention, there is provided an apparatus and a system for performing a simulated medical procedure, comprising: (a) a simulated interventional instrument for performing the simulated medical angioplasty procedure; (b) a motion detector circuit to provide navigation signals representative of the movement of the interventional instrument, the motion detector comprising a laser radiation detector, used for determining the location of the interventional instrument in a predetermined area at proximity of the detector and a laser radiation emitter used for emitting laser beam toward the predetermined area; (c) a movement calculation unit receiving the navigation signals from the motion detector circuit, programmed to calculate changes in position of the interventional instrument as it is maneuvered by the system operator. Preferably, the apparatus and system further comprising a tactile feedback mechanism for providing simulated tactile feedback according to the position of the interventional instrument.

According to one preferred embodiments of the present invention, the laser radiation detector is a complimentary metal-oxide semiconductor (CMOS) sensor, the laser emitter is used for illumination the interventional instrument in the area and the movement calculation unit calculates the interventional instrument precise location, speed and direction based upon changes in patterns over a sequence of consecutive photos.

According to other preferred embodiments of the present invention, the laser radiation detector produces output signal representing distance according to the distance between said radiation detector and said interventional instrument, wherein said laser radiation emitter is configured to emit a laser beam, said radiation detector is configured to detect light from said laser beam that as it reflected from said interventional instrument. More preferably, the movement calculation unit is configured to determine the position of the interventional instrument relatively to predetermined position, based upon the distance sensor signal and predetermined datum.

According to another embodiment of the present invention, there is provided a method for performing a simulated angioplasty procedure comprising the steps of: (a) providing a system for performing the simulated angioplasty procedure by applying motion to an interventional instrument and using a laser beam to measure movement of said instrument; applying said measured movement as an input to a software simulation of a vascular tract; (b) inserting the simulated interventional instrument into the simulated vascular tract; (c) receiving visual feedback according to the displayed image according to the interventional instrument as it is maneuvered by the system operator; (d) receiving tactile feedback according to the location of the interventional instrument within the vascular tract as it is maneuvered by the system operator.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a block diagram of the system for surgical simulation according to a first embodiment of the present invention;

FIG. 1B is an exemplary illustration of the intervention simulator device according to an embodiment of the present invention;

FIG. 2 is an exemplary illustration of a screen display according to an embodiment of the present invention;

FIG. 3 is a simplified motion detector according to a preferred embodiment of the present invention;

FIG. 4 is a block diagram, depicting the detectors operation phases of the motion detector according to a preferred embodiment of the present invention;

FIG. 5 is another simplified motion detector, according to a preferred embodiment of the present invention;

FIG. 6 is a simplified motion detectors array within an enclosure, according to a preferred embodiment of the present invention;

FIG. 7 is a flowchart of an exemplary method according to an embodiment of the present invention for the interaction of the trainee with the system and/or device of any of the previous Figures; and

FIG. 8 is an exemplary illustration of the resisting force generator mechanism, according to a preferred embodiment of the present invention.

### DESCRIPTION OF THE PREFERRED EMBODIMENTS

The present embodiments comprise an apparatus, system and a method for training students in the procedures of angioplasty.

The principles and operation of an apparatus, system and a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The apparatus and system as in the embodiment of the present invention discloses a unique technique for realistic visualization of the human anatomy and interventional instrument such as catheter or a guidewire thereof behavior under live fluoroscopy. The apparatus and system are enhanced with sensitive laser based motion detectors that provide navigation signals representative to the manipulations of the simulated interventional instrument. The laser based motion detectors generate signals that may be used to create a continuous flow of simulated images that is provided through a video monitor, which displays realistic images, according to the instantaneous manipulations of the simulated interventional instrument. Additionally, the apparatus and system are equipped with a force feedback mechanism, providing realistic tactile feedback that mimics the look and feel of an actual CathLab vasculature procedure, or angiography suite, preferably in such a manner that the tactile and visual feedback are linked as they would be in a human patient. The system is designed to enhance skills required across the range of invasive percutaneous cardio/endovascular procedures, including diagnostic angiography, angioplasty intervention, administering thrombolytic agents, and capabilities for recognition and management of developing complications. Thus, the apparatus, system and method of the present invention provide a realistic simulation of the medical procedure of angioplasty for training and testing students.

In particular, the present embodiments enable the trainee to perform a simulation of a diagnostic angiogram by inserting a catheter into an artery under fluoroscopic guidance, with subsequent injection of contrast material and imaging of the entire vascular system.

The trainee can assess the significance of vascular occlusive diseases as well as the outcome of an interventional procedure, by monitoring intra-arterial pressure gradients. Additionally, the trainee can perform full Angioplasty balloon dilation procedures, or similar procedures using a stent or other interventional devices, in various appropriate sites. Moreover, according to a preferred embodiment of the invention, the simulation device enables the user to practice monitoring patient's vital signs, performing full neurological examination, and administering drugs accordingly, all in a controlled and safe environment. Thus, preferably the trainee is exposed to a wide variety of situations and taught how to recognize and handle different medical situations in a plurality of formats.

In addition, the present embodiments are designed to improve technical and operational skills of the trainee while using X-rays and other CathLab equipment, by simulation and a display device that displays sequence of consecutive photos of fluoroscopic images and C-arm operation, providing images of still frames and structured graphical representation of various vascular tracts, cineangiographic and digital subtraction angiography and image archive management—an image reviewing facility that allows reviewing all archived images.

The principles and operation of a apparatus, system and method according to the present invention for medical simulation, and in particular for the simulation of the medical procedure of angioplasty, may be better understood with reference to the drawings and the accompanying description, it being understood that these drawings are given for illustrative purposes only and are not meant to be limiting.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

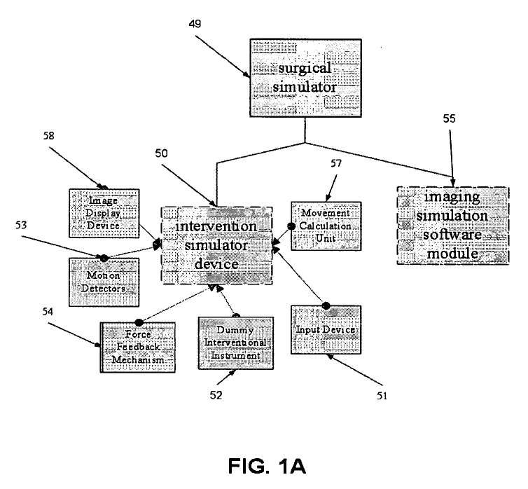

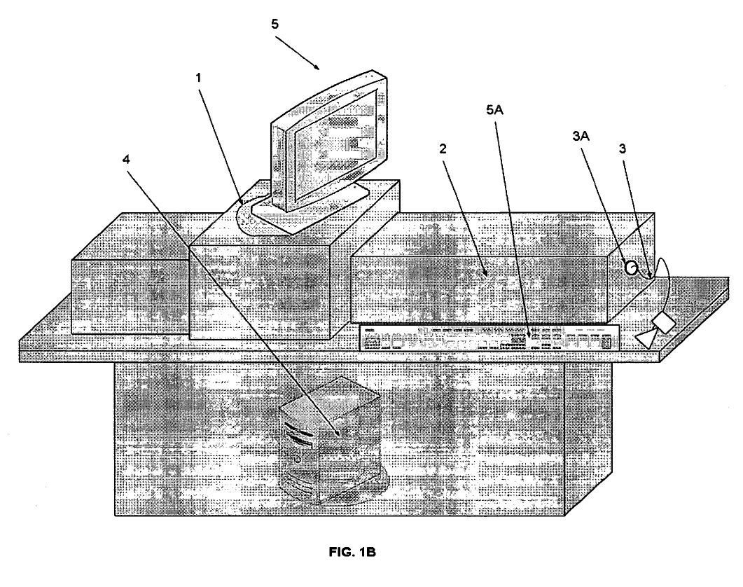

Referring now to the drawings, FIG. 1A is a block diagram representing the components of a system for simulation of an angioplasty procedure according to a first embodiment of the present invention. This surgical simulator (49) is comprised from two subsystems. The first subsystem is an intervention simulator device (50) constituted a dummy interventional instrument (52), an input device (51), motion detectors (53) a movement calculation unit (57), an image display device (58), and a force feedback mechanism (54). The second subsystem is an imaging simulation software module (55) that has the functions of receiving inputs from the motion detectors (53), analyzing the inputs using the movement calculation unit (57), translating the outcome to visual and tactile outputs and transferring them to the display device (58) and to the force feedback mechanism (54). The functions of the subsystems and the components will be presently described.

FIG. 1B depicts an exemplary, illustrative system for simulation of an angioplasty procedure according to an embodiment of the present invention. An intervention simulator device 1 includes an enclosure 2, a simulated interventional instrument, say a dummy catheter 3 or its guidewire (not shown), should be shown somewhere as this is a major feature of the invention and a movement calculation unit, say a computer processor unit 4 with a video monitor 5. An input device 5A is also connected to the processor, enabling the system operator with the ability to configure the simulation. A trainee interacts with the intervention simulator device 1 by manipulating dummy catheter 3, which is inserted into a cavity 3A within the enclosure 2. As the trainee 20 manipulates the dummy catheter 3, tactile and visual feedbacks are determined according to the position of dummy catheter 3 within the enclosure 2. A visual feedback is respectively provided in the form of a display on video monitor 5 and a tactile feedback is respectively provided from force feedback components within the system enclosure.

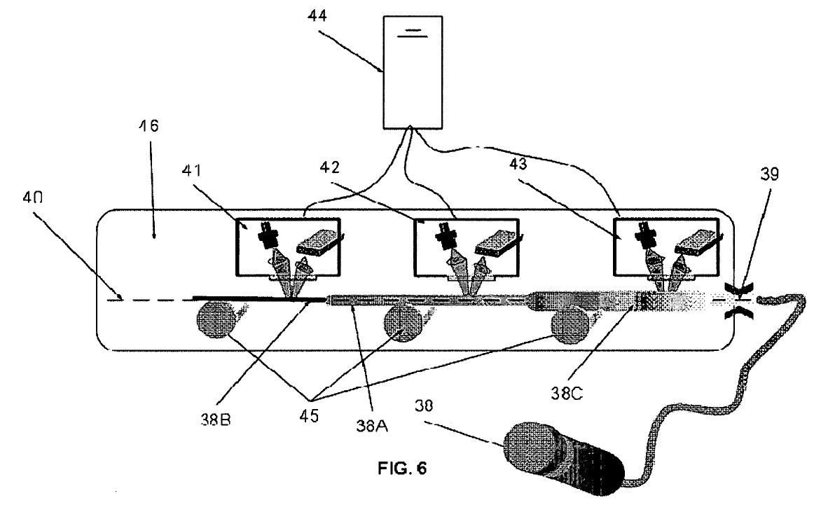

Referring now to FIG. 6, in a preferred embodiment, in use, when an interventional instrument 38 comprised from a dummy catheter 38A, a guidewire 38B and a deflated balloon 38C and is inserted into a cavity 39 within an enclosure 46, along axis 40, it passes through the three laser based motion detectors 41, 42, 43, which are located in parallel to the dummy catheter advancement axis 40. Additionally, in this preferred embodiment resisting force generators 45 are located along axis 40, enabling the activation of force feedback on the interventional instrument 38. When the interventional instrument 38 passes through the first motion detector 43 it is illuminated by the laser diode and its movements are reflected onto the detector photodiode detectors. The movement is detected and relayed to the processor as navigation signals. The processor 44 analyzes the catheter instantaneous positional information according to the current navigation signals. During the advancement of catheter it passes through the bounded working area of the additional motion detectors 42, 41. When the movement of the catheter is detected by the additional motion detectors 42, 41 it relayed to the processor. At this stage the computer processor unit 44 receives navigation signals from more then one motion detector and analyzes the catheter 38A, guidewire 38B and balloon 38C instantaneous positional information more accurately according the positional information from each detector respectively to its position, relatively to the other detectors position.

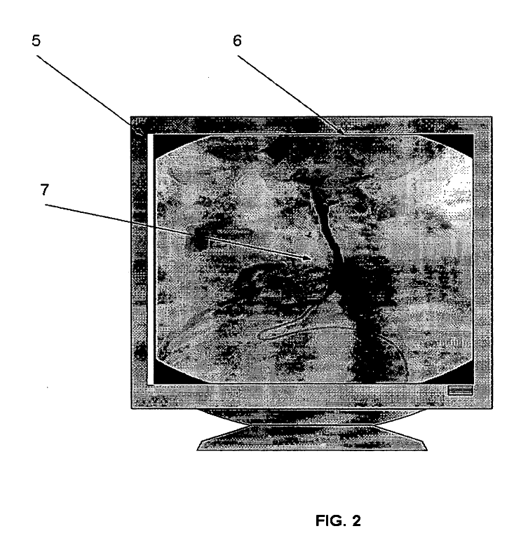

FIG. 2 is an exemplary illustration of a screen display shown on monitor 5. A screen display 6 includes a real time feedback image 7 as transferred from the imaging simulation software module. The real time Feedback image 7 represents the visual image as seen if the dummy catheter and a guidewire were inserted into a living human patient. Feedback image 7 is an accurate and realistic simulation of the visual data that would be received from that portion of the vascular tract in the living human patient. Although real time feedback image 7 is shown herein as a static image, it is understood that this is for illustrative purposes only and the actual visual feedback data would be in the form of a substantially continuous flow of simulated images based upon actual video stream data obtained from an actual angioplasty procedure, the flow being modified according to detected movements from the simulated intervention device by an imaging simulation software module. Thus, the flow of images represented by real time feedback image 7 gives the trainee realistic visual feedback.

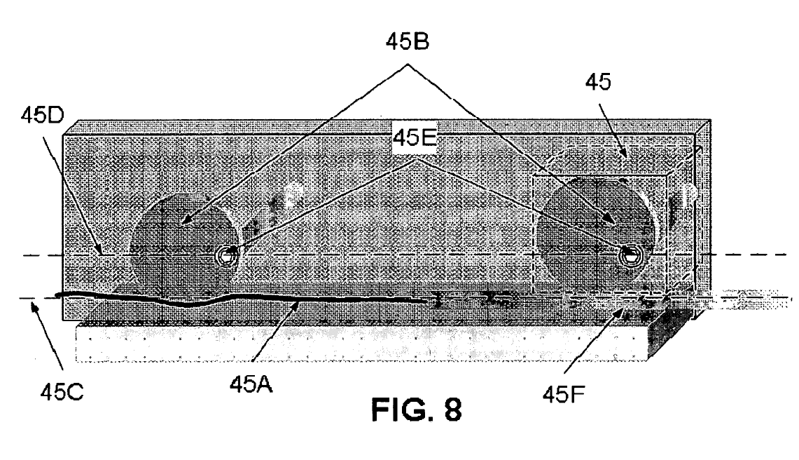

FIG. 8 outlines a resisting force generator 45 within a preferred embodiment of the present invention. The resisting force generator 45 is used to simulate the tactile feedback of the procedure respectively to the catheter 45F or the guidewire movement 45A within the simulated vascular tract. The resisting force generator 45 imparts different pressure on the catheter or the guidewire respectively to the movement signals as received from the imaging simulation software module. This pressure simulates the actual tactile feeling the physician experience during a real angioplasty procedure and reflect the actual reaction of the patient tissues to the catheter manipulation. In a preferred embodiment of the invention, the resisting force generator 45 is actually a wheel 45B positioned in the proximity of the catheter advancement axis 45C. The wheel rotation axis 45D is positioned in the proximity of the wheel edge 45E in a manner that the rotational position of the wheel can impart different amount of pressure on the catheter or its guidewire.

Referring once again to FIG. 6, we will elaborate bellow on the imaging simulation software module according to the presently preferred embodiments. The imaging simulation software module (hereinafter: “imaging module”), through the processor, is utilized to prepare a simulated organ visual images as displayed on the screen during the actual angioplasty procedure, like, inter alia, shown in FIG. 2, and for rendering the visual feedback of the simulated organ during the simulated angioplasty procedure to a visual display device. The imaging module simulats a plurality of vascular tracts, according to the input device instructions as set by the trainee.

At the same time, the imaging module receives navigation signals from the motion detectors 41, 42, 43 which are located along the enclosure cavity. The imaging module uses the processor to calculate the catheter position within the enclosure cavity according to the navigation signals and updates the visual image of the vascular tract, as described above, with the instantaneous respective position of the interventional instrument 38. Moreover, if the trainee maneuvers the catheter 38A, the guidewire 38B and the deflated balloon 38C, in a manner that if performed on a real patient would harm or effect the patient vascular tract, the imaging module simulates a negative reaction of the vascular tract to the interventional instrument maneuvers.

In addition, and in correspondence with the visual information, the imaging module also operates the resisting force generators 45 in a manner that simulates the instantaneous tactile feedback of the procedure. Such visual images and tactile feedback simulate the actual feedback as received during an actual medical procedure as performed on an actual subject and therefore reflect to the trainee the current location and bending of the interventional instrument along the simulate vascular tract.

Clearly, the system is not bound to the simulation of a particular vascular tract, but can reflect a visual display of various vasculature elements relative to the instantaneous position of the interventional instrument.

Since surgical simulators that simulate image guided angioplasty surgery are already disclosed and comprehensibly described in the incorporated patents, this description is focused on the mechanism for detecting the motions of the dummy interventional instrument relative to the predetermined sites within the enclosure.

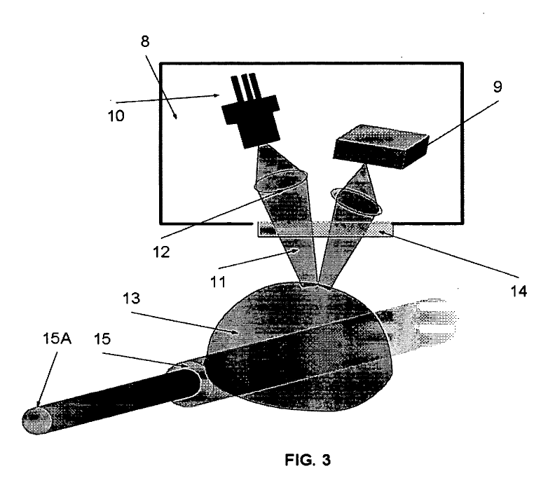

FIG. 3 outlines a motion detector 8 within a preferred embodiment of the present invention. The figure shows a simplified representation of a cut-away side view of the motion detector and the proximity area thereof. The motion detector is located within a cavity at the enclosure 3A and includes an image sensor 9, for example complementary metal-oxide-semiconductor image sensor, a laser diode 10, which is used to emit light 11, preferably projected by lens 12 (which instead of being separate may be an integral part of the laser diode package) onto a predetermined bounded area 13, designated for the passage of the interventional instrument, say a dummy catheter 15 and its guidewire 15A. Additionally, the motion detector 8 may include a window 14 that is transparent to light from the laser diode, and which would serve to keep dust, dirt or other contamination out of the innards of the motion detector. In a preferred embodiment an image of the illuminated bounded working area 13 is projected through a transparent window 14 onto an image sensor 9, comprised from an array of photo detectors (not shown). The photo detectors comprise a square array of, say, 32 by 32 photo transistors on a side. The image sensor 9 is suitable for taking more than 6000 snapshots per second. The photo transistors charge capacitors whose voltages are subsequently digitized and stored in a memory. The integrated circuit is preferably held in place, as part of a printed circuit board, and the shape and composition of the lenses, and how the lenses are mounted are all carried out in a conventional manner. It is also clear that the general level of illumination of region 13 may be controlled by detecting the output levels of the photo detectors and adjusting the intensity of light issuing from the laser diode 10.

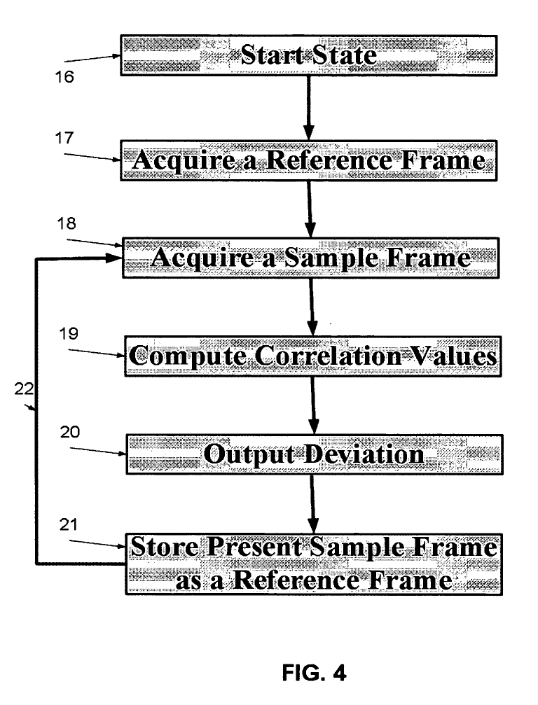

Reference is now made to FIG. 4, wherein is shown a flow chart 29 that describes a process of using a laser-based motion detector. Assuming there is a start state in the initial stage of the process 16 from which we reach the step of acquiring a reference frame 17. During this step the bounded working area is already illuminated using a laser diode. The motion detector stores a collection of digitized detector values in an array of memory that represents the light reflected from the bounded working area into an image sensor. In the next step 18, which occurs after several microseconds, the motion detector acquires another frame in the same manner it did during previous step, except that the data is stored in a different memory array. During the subsequent step 19, the motion detector computes the correlation values of the deviation between the reference frame and the sample frame, which was acquired during steps 16 and 17. The correlation values are computed by dedicated arithmetic hardware assisted by automatic address translation During the following step 20 the motion detector outputs the calculated motion values reflecting the dummy catheter motion since the last measurement cycle. These motion values may be accumulated into running values that are sent together to the processor. During the subsequent step the motion detector stores the present sample frame as a reference frame 21, and starts another measurement cycle 22 in order to calculate the future motion of the catheter in a proximate time interval based upon the new reference frame.

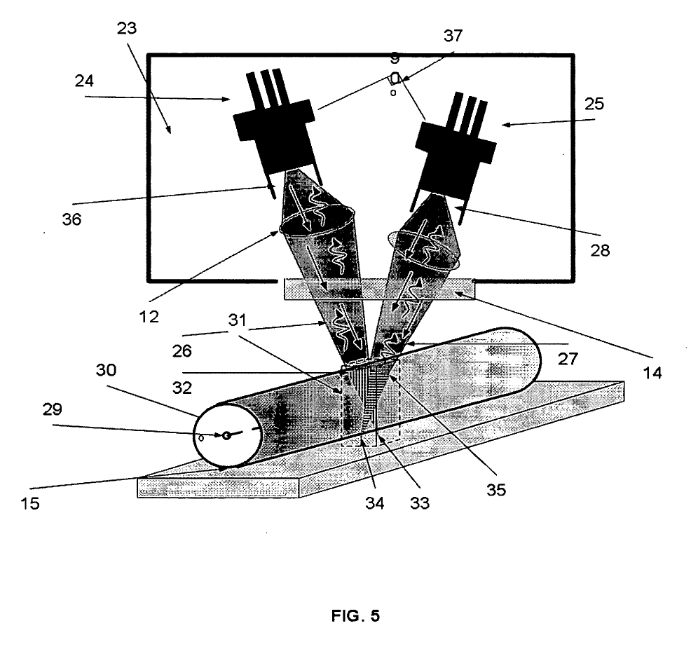

Another preferred embodiment of the present invention motion detector 23 is shown in FIG. 5. The motion detector 23 comprises two laser-emitting and detecting units 24, 25 which may include laser diodes. The units 24, 25 are arranged preferably in the corners of the motion detector, vertically to one another 37, and respectively emit laser beams 26, 27 which are directed to the center of the bounded working area. Each unit preferably comprises a laser diode that is used for emitting a laser beam and used for detecting the light scattered back. The laser beams are generated in such a way that they are emitted respectively through a tube 28, 36 in the emitting top of the laser-emitting and detecting units 24, 25 to a space above the intended passage axis 29 of the interventional instrument, say a dummy catheter 30. When the dummy catheter 30, is within the boundaries of the motion detector working area 31, the laser beams 26, 27 are reflected or scattered back from the dummy catheter 30 through the tube 28, 36. The light output of the diodes thus undergoes modulations (undulations) when reflected from the dummy catheter through the tube 28, 36. Since the laser diodes are current-modulated, the effect can be used to measure the distance between the laser diodes and the place of reflection of the laser beams. Thus, if no interventional instrument 30 is found within the boundaries of the working area, the distances between the laser-emitting and detecting units 26, 27 and the respective point of the frame 33, 34 are measured and transferred to the processor, indicating the absence of any interventional instrument. However, if an interventional instrument, say a dummy catheter 30, is placed within the boundaries of the working area 31, the laser beams 26, 27 are interrupted and reflected or scattered respectively from the dummy catheter 32, 35. Thus a shorter distance between the laser-emitting and detecting unit 5 and the point of reflection of the laser beams 26, 27 will be measured and transferred to the processor, indicating the presence of the dummy catheter. This signal alteration can be used to trigger an interrupt reporting the event that the interventional instrument is present within the boundaries of the working area.

In addition, since the laser diode itself is current-modulated and its beam undergoes modulation, the movement direction of the dummy catheter can be detected using an Interference and Doppler Effect calculation. Thus, the movement direction of the dummy catheter on a certain axis can be transferred to the processor.

In this preferred embodiment, the laser-emitting and detecting units emitting top are positioned orthogonally with respect to one another 37 in a manner that the movement direction of the dummy catheter in two perpendicularly axis are measured and used for calculating up-down movements and left-right movements of the dummy catheter.

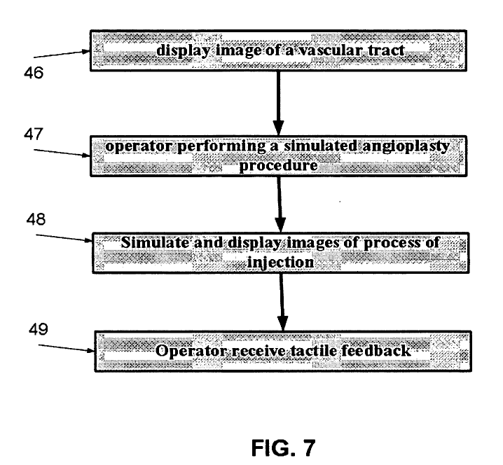

FIG. 7 is a flowchart of an exemplary method according to a preferred embodiment of the present invention for the interaction of the student with the system and/or apparatus.

As shown, in step 46, the image of a vascular tract is displayed to the operator on the display screen/monitor 46. The image is preferably constructed as previously described with regard to FIG. 2.

In step 47, the operator performs angioplasty procedure by inserting a catheter instrument into the simulated vascular tract 47; and in step 48, the “reaction” of the surrounding tissue to the procedure, as well as the image of the catheter itself, is preferably simulated as part of the image being displayed on the display screen/monitor at step 49 the operator will receiving tactile feedback according to the positioning and maneuvering of the catheter within the simulated vascular tract 49.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for performing a computerized simulation of a medical angioplasty procedure, the apparatus comprising:
a physically simulated interventional instrument for providing user input to said simulated medical angioplasty procedure;
a laser-based motion detector to provide signals representative of the movement of said physically simulated interventional instrument, said laser-based motion detector comprising a laser source and laser radiation detector, said motion detector configured to determine the location of said physically interventional instrument within a predetermined inspection area at proximity thereof using detection of reflected radiation of said laser source, therewith to provide said signals; and
a movement calculation unit configured to receive said signals from said laser-based motion detector, therefrom to calculate changes in position of a corresponding calculated interventional instrument as it is maneuvered in said simulation.

2. The apparatus of claim 1, further comprising a tactile feedback mechanism for providing simulated tactile feedback to said physically simulated interventional instrument according to said position of said calculated interventional instrument within said simulation.

3. The apparatus of claim 1, wherein said radiation detector is a complimentary metal-oxide semiconductor (CMOS) sensor.

4. The apparatus of claim 1, wherein said laser emitter is used for illumination of said interventional instrument in said inspection area.

5. The apparatus of claim 1, wherein said movement calculation unit is configured to calculate the interventional instrument precise location, speed and direction based upon changes in patterns over a sequence of consecutive image captures.

6. The apparatus of claim 1, wherein said radiation detector circuit comprises a group of photodiodes.

7. The apparatus of claim 6, wherein said radiation detection circuit is configured to carry out more than 1000 image captures per second.

8. The apparatus of claim 1, wherein said interventional instrument comprises a catheter.

9. The apparatus of claim 1, wherein said interventional instrument comprises a catheter's guidewire.

10. The apparatus of claim 1, wherein said interventional instrument comprises a pipelike medical instrument.

11. The apparatus of claim 1, wherein said laser-based motion detector comprises a laser diode, used for illuminating said inspection area.

12. The apparatus of claim 1, wherein said motion detector circuit comprises more than one radiation detector.

13. The apparatus of claim 1, further comprising a visual display unit for displaying said computerized simulation as images that simulate the position of said interventional instrument in an actual medical procedure, based on the measured instantaneous position of said interventional instrument.

14. The apparatus of claim 13, further comprising an imaging simulation software module for simulating various vasculature elements relative to the said instantaneous position of said interventional instrument, such that said images simulate actual visual data received during an actual medical procedure as performed on an actual subject.

15. The apparatus of claim 1, wherein at least said motion detector circuit and said tactile feedback mechanism are housed within an enclosure, and said enclosure has an external opening through which said interventional instrument member can be received.

16. The apparatus of claim 15, further comprising more than one of said motion detectors spaced circumferentially around said enclosure.

17. The apparatus according to claim 15, wherein, three of said motion detectors spaced are located along said enclosure, wherein, said interventional instrument comprises three co-axial components; each of said motion detectors being used for determining the motion of one of said coaxial components.

18. The apparatus of claim 1, wherein said laser radiation detector is configured to produce an output signals representing the distance between said radiation detector and said interventional instrument and the movement direction of said interventional instrument, said distance and said movement direction are being measured using said laser beam.

19. The apparatus of claim 18, wherein said movement calculation unit is configured to determine the position of said interventional instrument relative to a predetermined position, based upon said output signals and a predetermined datum.

20. The apparatus of claim 18, wherein motion detector comprises more than one set of said radiation source and said radiation detector.

21. The apparatus of claim 18, wherein at least said motion detector and said tactile feedback mechanism are housed within an enclosure, and said enclosure has an external opening through which said interventional instrument member can be received.

22. Apparatus according to claim 21, further comprising more than one of said motion detectors spaced about said enclosure.

23. The apparatus according to claim 21, wherein, three of said motion detectors spaced along said enclosure, wherein, said interventional instrument comprises three co-axial components; each of said motion detectors being used for determining the motion of one of said coaxial components.

24. A system for performing a simulated medical angioplasty procedure comprising:
a simulated interventional instrument for providing user input to said simulated medical angioplasty procedure;
a motion detector circuit to provide navigation signals representative of movement and rotational position of said interventional instrument, said motion detector circuit comprising a laser radiation emitter used for emitting a laser beam toward a predetermined inspection area, and a laser radiation detector for detecting laser radiation from said predetermined inspection area, and said detector circuit being configured for determining said motion of said interventional instrument thereby to provide said navigation signals;
a movement calculation unit configured to receive said navigation signals from said motion detector circuit and calculate a position of a corresponding interventional instrument within said simulation;
a tactile feedback mechanism for providing simulated tactile feedback according to said calculated position of said corresponding interventional instrument; and
a visual display means for displaying images of the instantaneous position of said corresponding interventional instrument within a body environment comprising vasculature, such that said images simulate actual visual data received during an actual medical procedure as performed on an actual subject.

25. A method for performing a simulated angioplasty procedure, the method comprising:
a) applying motion to a physically simulated interventional instrument
b) using a laser beam detector to measure movement of said physically simulated instrument;
c) applying said measured movement as an input to a software simulation of a vascular tract; and
d) using said measured movement to update a position of a corresponding software simulated interventional instrument within said simulated vascular tract.

26. The method of claim 25, further comprising calculating tactile feedback within said software simulation according to said position and provide said calculated tactile feedback to said physically simulated interventional instrument.

27. The method according to claim 25, wherein said using a laser beam detector comprises using a plurality of laser beams to measure separately the locations of parts of said physically simulated interventional instrument.
